(19) United States
(12) Patent Application Publication
(10) Pub. No.: US 2025/0032827 A1
(43) Pub. Date: Jan. 30, 2025

(54) KNEE SLING AND METHOD OF USE

(71) Applicant: AVID STRATEGIC LLC, Frankenmuth, MI (US)

(72) Inventor: SCOTT LEE, FRANKENMUTH, MI (US)

(21) Appl. No.: 18/226,090

(22) Filed: Jul. 25, 2023

(51) Int. Cl. A62B 35/00

(52) U.S. Cl. CPC A62B 35/0025

(57) ABSTRACT

A saddle or harness is worn by a user when tethered to a tree or pole to suspend the user. A knee sling is releasably attachable to the saddle or harness to extend forwardly along the user's thighs and to wrap about the user's knees such that when the user leans the wrapped knee sling into the tree or pole with knees spaced the knee sling flexes to receive the tree or pole into the space between the knees and the sling further conforms to form convex knee pockets on laterally opposite sides of the tree or pole for supporting the user's knees in straddled relation to the tree or pole. The knee sling is adjustable in length to adjust for different size trees or poles.

### BACKGROUND

### 1. Technical Field

This invention relates generally to knee support devices used to support a person' knees against a tree or pole when suspended in a hunting saddle or climbing harness.

### 1. Related Art

Hunters and lineman utilize hunting saddles and climbing harnesses connected to a tether line secured about a tree or pole to suspend themselves at an elevated position. It is common for such persons to adjust their position while suspended for access and comfort, including in a sitting or knees-bent position where the person's knees are braced against the tree or pole. Extended contact of the person's knees against the tree or pole can cause fatigue and soreness. To alleviate the discomfort in the case of saddle hunters, such persons have been known to strap pads to the tree to create a cushioning of the knees or to wear knee pads. The strapped pads are bulky and work for a single position. They can also be noisy. Knee pads can themselves become uncomfortable over time as the elastic bands that wrap about the back of the leg cause pressure points and constriction and produce a binding sensation, especially when worn over top of heavy hunting clothing. Knee pads can also be noisy, especially those with a hard exterior shell that scrubs against the tree.

What is needed is a solution for knee support that overcomes the many problems known with current approaches.

### SUMMARY

A sling assembly is provided for supporting the knees of a person against a tree or pole while suspended in a climbing saddle or harness. The assembly comprises a sling of flexible material having a front side and a back side and extending longitudinally between opposite first and second ends. A first strap assembly extends from the first end of the sling. A second strap assembly extends from the second end of the sling. The first and second strap assemblies each having connectors for releasable attachment to the saddle or harness. At the first strap assembly includes at least one length adjustment device to enable the hunter to selectively increase or decrease the effective length of the first strap assembly. When the connectors of the first and second strap assemblies are releasably secured to the saddle or harness, the sling forms a closed loop with the saddle or harness. The strap assemblies extend along the thighs of the user and wrap around the user's knees. The back side of the sling is engagable with the tree or pole in a space between the user's knees, shaping the sling into a serpentine M-shape under the weight of the user and creating convex knee pockets on the front side of the sling on opposite sides of the tree or pole to receive and support the knees of the user. A convex pocket is formed on the back side of the harness to receive the tree or pole into the space between the user's knees. The assembly has the advantage of supporting the knees in a comfortable position on either lateral side of the tree or pole. The assembly has the further advantage of utilizing both the saddle or harness and the tree, together with the weight of the user to shape the sling to provide stable and comfortable support to the user's knees and avoids the discomfort and binding associated with the known prior knee support approaches. The assembly also has the advantage of being quite and being able to move with the person to different positions around the tree. The assembly has the further advantage of being adjustable in length to accommodate different diameter trees or posts while still forming supportive pockets laterally of the tree or post. Climbing trees for hunting, for example, can range from 10 to 22 inches in diameter and adjusting the straps to make them longer enables the user to receive a larger tree in the space between the knees while still forming the knee pockets to either side, and adjusting the straps to be shorter allows for smaller diameter trees to be received while providing lateral knee pocket support to the knees. The length adjustment changes the overall circumferential length of the sling assembly at its connection points to the saddle or harness, thus taking into account that the distance from the saddle along the thighs to the user's knees is fixed, while the size of the tree or pole can vary such that shortening the effective length provides effective knee support for smaller trees or poles, and increasing the effective length provides the same effective knee support but with larger diameter trees or poles.

A method of supporting a user's knees while suspended in a tree or pole while wearing a saddle or harness is also provided. The method includes connecting opposite ends of a knee sling to the saddle or harness to form a knee sling loop. The loop is positioned along the user's thighs and wrapped forward around the user's knees. When the user leans into the tree or pole, the knee sling engages the tree on a backside of the knee sling and supports the user's knees on a front side. The same advantages are realized including forming comfortable and stable knee pockets when the knees are spread to straddle the tree or pole which is received into the space between the knees.

Also provided is a combination, which includes a saddle or harness and a knee sling. The saddle or harness is to be worn by a user when tethered to a tree or pole to suspend the user. The knee sling is releasably attachable to the saddle or harness to extend forwardly along the user's thighs and to wrap about the user's knees. When the user leans the wrapped knee sling into the tree or pole with knees spaced, the knee sling flexes to receive the tree or pole into the space between the knees and the sling further conforms to form convex knee pockets on laterally opposite sides of the tree or pole for supporting the user's knees in straddled relation to the tree or pole.

The problem of direct knee contact with the tree or pole is thus overcome. The further problem of knee support systems provide in fixed positions on a tree is also overcome. The further problem of uncomfortable knee pad supports worn by a user to cushion the knees against a tree are also overcome. The problem of noisy knee support systems which can draw unwanted attention to wild game is also overcome. The solution is simple, comfortable, quiet, moveable with the user relative to the tree, adjustable to provide stable and effective knee support when used with a wide range of tree or pole diameters, and is easily adjustable using adjustable straps.

### THE DRAWINGS

These and other features and advantages will be better understood when considered in connection with the following detailed description and drawings, in which:

FIG. 1 is an environmental perspective view of the assembly;

FIG. 2 is a rear perspective view;

FIG. 3 is a front perspective view;

FIG. 4 is a rear plan view;

FIG. 5 is a front plan view;

FIG. 6 is fragmentary perspective view of a connection portion of the assembly;

FIG. 7 is a fragmentary perspective view of an adjustment slider;

FIG. 8 is top view with a portion broken away;

FIG. 9 is top perspective view; and

FIG. 10 is another top perspective view.

### DETAILED DESCRIPTION

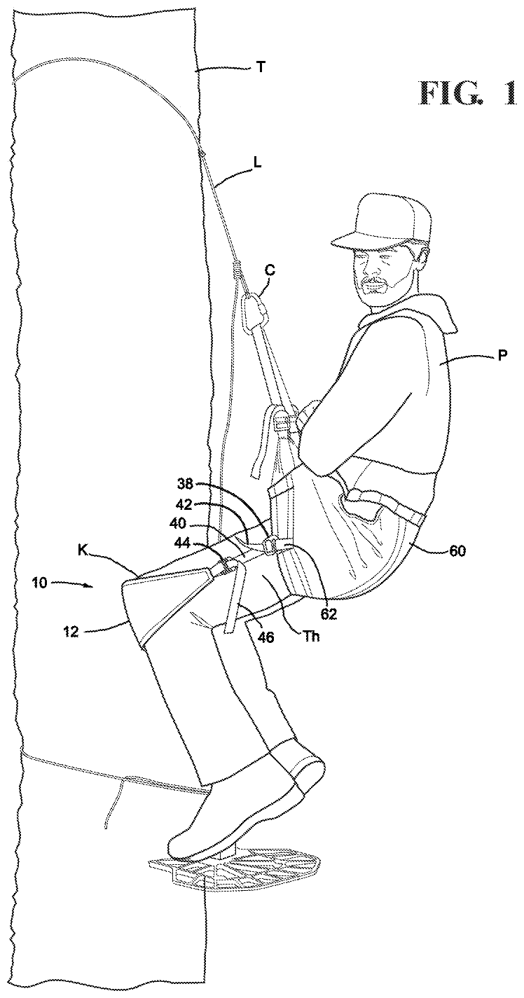

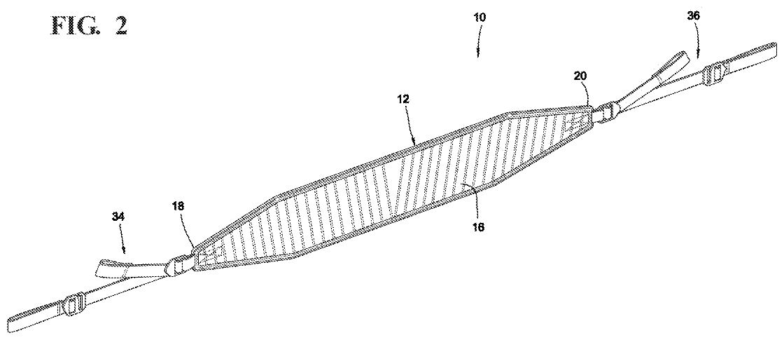

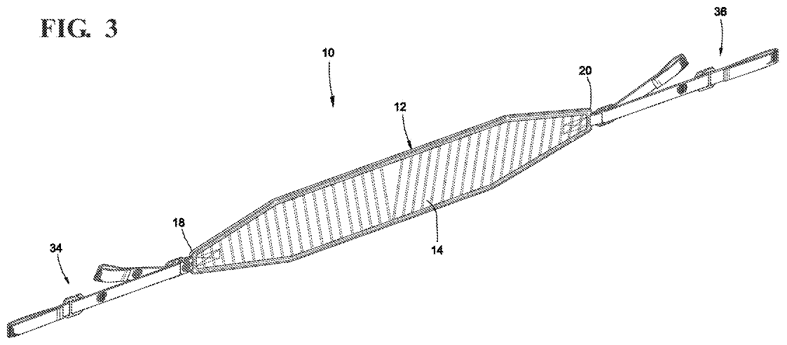

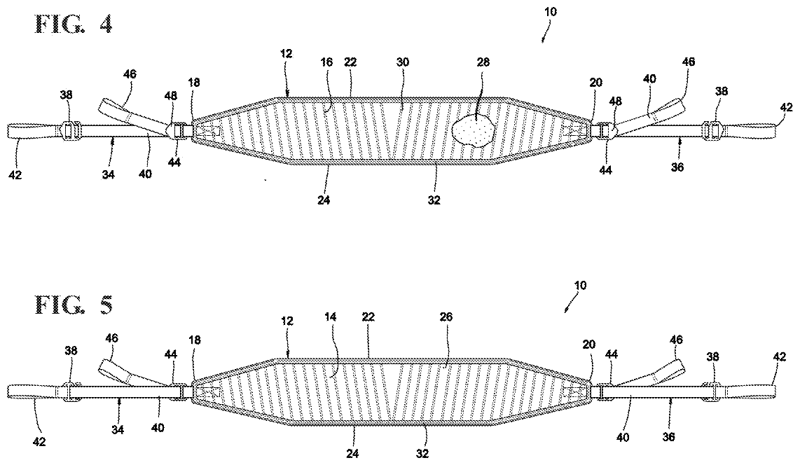

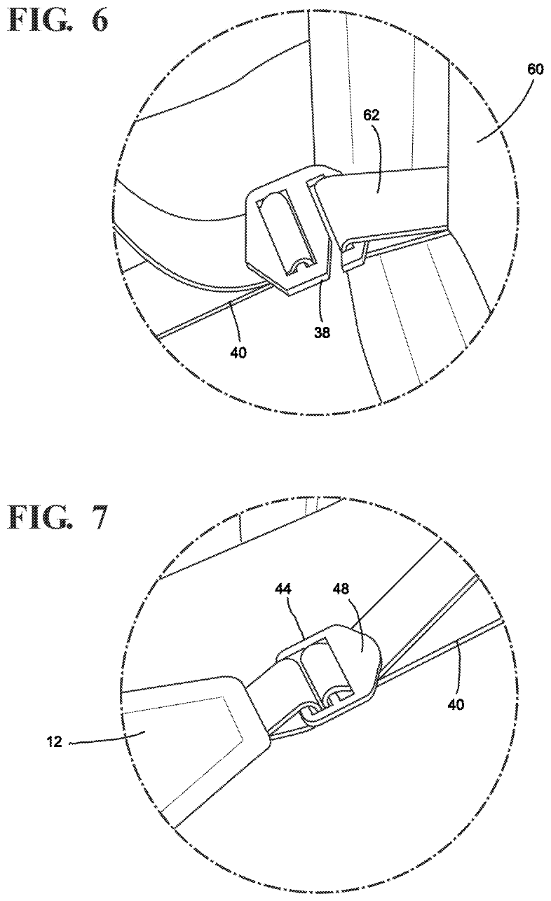

A sling assembly 10 is provided for supporting the knees K of a person P against a tree or pole T while suspended in a climbing saddle or harness 60 by a tether line T with a carabiner C, as illustrated in FIG. 1. With additional reference to FIGS. 2-5, the assembly 10 comprises a sling 12 of flexible material having a front side 14 which faces the user when in use and a back side 16 which faces away from the user when in use. The sling 12 extends longitudinally between opposite first 18 and second 20 ends and extends widthwise between a top edge 22 and a bottom edge 24.

The sling 12 may be fabricated of single layer, such as rubber-coated nylon open mesh (e.g., Hypalon), but is preferably made of multiple layers. The sling 12 is flexible, meaning it can bend and conform against shapes, including when wrapped about the user's thighs Th and knees K and pressed against the tree or pole 12, as will be described in further detail below. The sling 12, while flexible, is preferably non-elastic such that it can bear a load from the weight of the user and conform its shape, but it does so preferably without stretching. It is to be understood that the invention is not limited to using non-stretch materials, but they are preferred and have their advantages. The multi-layer material includes a front layer 26, and intermediate layer 28 and a back layer 30. The front layer 26 is positioned in direct contact with the user P when in use. The back layer 30 is positioned away from the user P and engages the tree or post T when in use. The intermediate layer 28 is sandwiched between the front 26 and back 30 layers. The front and back layers 26, 30 preferably comprise open mesh fabric. The back layer 30 may preferably comprise a heavy duty mesh that is flexible but is fairly stiff and of high durability for withstanding abrasive contact with the tree or post T. The front layer 26 is of lighter open mesh fabric. The intermediate layer is preferably of padding material and more particularly foam padding and still more particularly a thin perforated foam layer such as EVA foam. The layers 26, 28, 30 provide comfort, flexibility and are breathable. The perimeter of the sling 12 may be trimmed in bias tape 32 which flexes and conforms with the layers 26, 28, 30.

A first strap assembly 34 extends from the first end 18 of the sling 12. A second strap assembly 36 is separate from the first strap assembly 34 and extends from the second end 20 of the sling 12. The strap assemblies 34, 36 are thus individual and each has a free end away from the sling 12. The first and second strap assemblies 34, 36 each have connectors 38 for releasable attachment to the saddle or harness 60. A preferred connector 38 is a slider G-hook buckle. Each strap assembly 34, 36 includes a strap 40 preferably in the form of a length of webbing, such as nylon webbing. The G-hook buckles 38 are each positioned adjacent the free ends of the straps 40 and the straps 40 can be slid relative to the G-hook buckles 38 to adjust the effective length of the straps 40. A free end portion 42 of the straps 40 beyond the G-hook buckle may comprise a loop. The loops 42 may be easily grasped by the user P for adjustment of the straps 40 relative to the G-hook buckle 38. The saddle or harness 60 preferably is fitted with mounting loops 62 along the thigh or hip area of the saddle or harness 60. The G-hooks 38 can be easily and quickly slipped into the saddle loops 62 for securing the ends of the strap assemblies 34, 36 to the saddle or harness 60. Another option is to connect the free end loops 42 of the straps 40 to structure of the saddle or harness 60, such as a loop or strap, by carabiners or other releasable connectors (not shown). In this way, the loops 42 can serve as the connector 38 in lieu of the G-hooks 38, if desired by the person P based on preference or the type of saddle or harness 60 being used. Ideally, but not essentially, the attachment points of the straps 34, 36 to the saddle or harness 60 is in line with the person's thighs Th and as such the anchor points (such as loops 62) are preferably positioned on the saddle or harness 60 to be in line with the user's thighs and preferably along the hip support area of the saddle or harness 60.

The strap assemblies 34, 36 preferably include a further slider buckles 44 that enable adjustment in the effective length of the webbing straps 40 independently of the G-hook slider buckle 38. In other words, the strap assemblies 34, 36 have at least a primary length adjuster, which preferably is in the form of the slider buckles 44, but may have secondary length adjusters, which in the embodiment is performed by the G-hook slider buckles 38. The slider buckles 44 are spaced from the G-hook buckles 44. The slide buckles 44 may be fixed to the ends 18, 20 of the sling 12 by short loops of webbing. Adjacent end portions of the webbing strap 40 are fed through the buckles to enable slidable adjustment to the effective length of the straps 40. The free ends of the straps 40 extending from the G-hook connector 38 and slider buckles 44 may be formed into pull loops 42, 46, respectively for ease of grasping by the user when adjusting. Pulling either of the loops 42, 46 shortens the straps 40, while tilting the release tab 48 of the buckle 44 releases the strap 40 for lengthening. The free end loops 42, 46 are arranged with respect to their buckles 38, 44 to extend toward one another, such the tightening of the straps 40 can be achieved by pulling forward on loops 42 and/or by pulling rearward on loops 46.

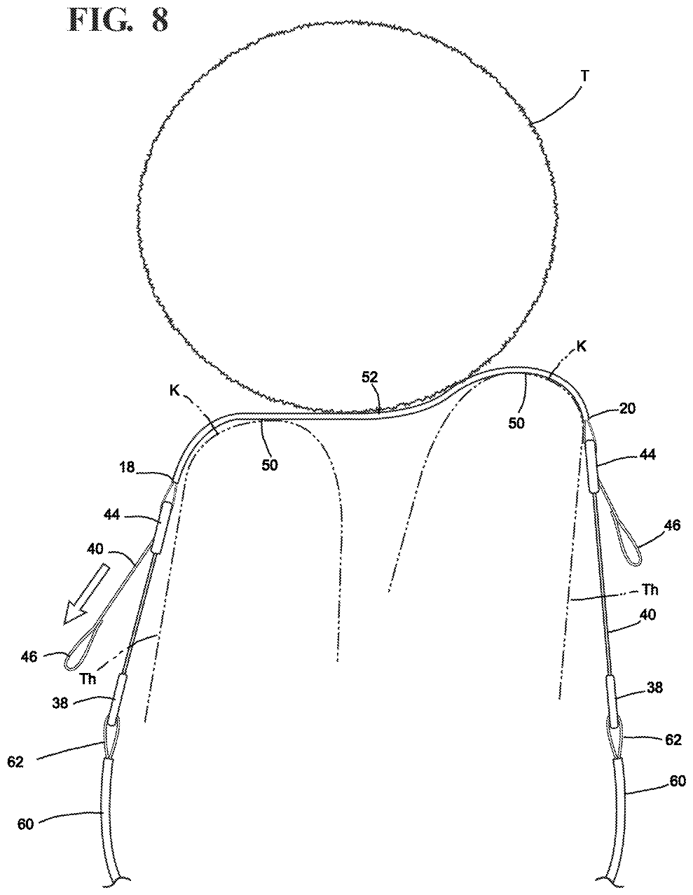

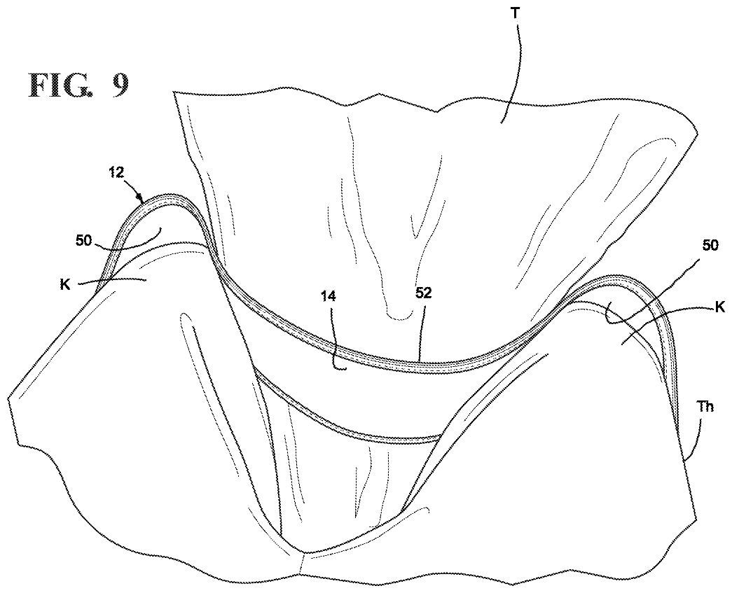

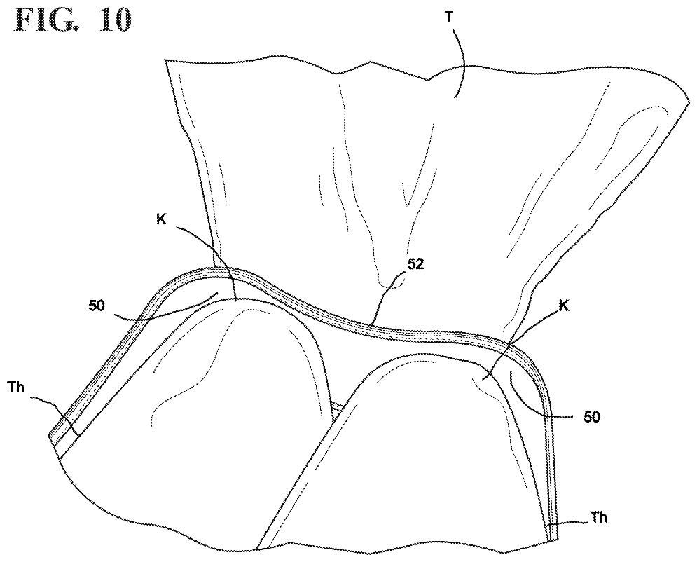

When the G-hooks 38 are secured in the saddle loops 62, the assembly 10 extends forwardly of the saddle or sling 60 with the strap assemblies 34, 36 extending along the user's thighs Th and the sling 12 wrapping around and bridging across the user's knees K, as illustrated in FIGS. 1 and 8-10. It will be appreciated that the distance between the anchor points of the assembly on the saddle or harness and the user's knees is defined and fixed for each person. This “thigh” measure does not change during use for a given person P. The distance between the knees K can vary depending primarily on the size of tree or post from which the user is tethered or the spacing preference of the user, as illustrated by FIGS. 9 and 10. With the front side 14 of the sling 12 engaging the user's knees K, the user leans into the tree or post T with the knees K straddling the tree or post T. The weight of the user P and the resistance from the tree or post T causes the sling 12 to flex as the tree or post T presses inward of the space between the user's knees K. At the same time, the user's knees K are pressing outward and the result is the sling 12 taking on an M-shape as illustrated in FIG. 9, with the knees K supported in concave knee pockets 50 on the front side 14 of the sling 12 on laterally opposite side of the tree or post T, and the tree or post T being received in an intermediate tree pocket 52 on the back side 16 of the sling 12. In this way, the user's knees K are straddling the tree or post 12 but not directly contacting the tree or post T.

As the user leans into the tree or post T, it will be apparent or intuitive that adjustments may need to be made to the effective length of the assembly 10 depending on the diameter of the tree or post T or the preference of the person P. For a smaller tree or post T, the user may grab and pull one or both loops 42, 46 to shorten the length of the assembly 10 to achieve comfortable pocketing of the knees K on either side of the tree or post T in the sling 12. If on the other hand the user determines the tree or post T to be larger, the user can release tension on the straps 40 by lifting the release tab or tabs 48 of slide buckles 44 to loosen the straps 40, and then may further adjust by pulling on the loop or loops 42, 46 as needed to snug the sling 12 to achieve the desired pocketing of the knees K in the sling 12 when straddling the tree or post T, as shown in FIG. 9. The person can also adjust the straps 34, 36 to bring the knees K closer together as in FIG. 10, which decreased the size of the knee pockets 50 but still gives lateral support to the person's legs for stability and comfort. The length adjustment feature thus enables the person to adjust the sling 12 into any of a number of positions to attain the desired comfort and stability while suspended in the sitting position. The length adjustment also enables the person to adjust the sling 12 to accommodate a wide range of shapes and sizes of trees or poles T as needed.

The dimensions of the assembly 10 are important considerations to make the assembly 10 suitable as a knee sling support 10. The overall length needs to be long enough to connect to the saddle or harness 60, extend along the thighs Th and wrap about the knees K of the user P, and to accommodate trees or poles of varying diameters that may range from as small as 7 inches to as large as 22 inches or more. The tree or pole T should nest between the user's knees K to achieve a desired stable and comfortable straddling of the tree or post T as a primary support position of the person P. At the same time, the user's knees K need to be pocketed by the sling 12 and the sides of the legs supported laterally by the sling 12 and straps 34, 36 with the right tension to achieve effective support. The adjustment features thus also play an important role especially considering the large range of tree sizes. It will be appreciated that the distance from the anchor point of the assembly 10 on the saddle to the user's knees (i.e., along the thighs) is a fixed number for each person and this does not change when the user changes position or changes trees or poles. The main variable is the tree or pole diameter and the length adjustment adds or subtracts from the span of the segment of the sling 12 in the space between the person's knees and which engages and conforms to the tree or post T on the rear side 16 of the strap. A larger tree or post T requires a longer segment of sling material 12 to wrap about the larger section of tree T between the straddling points of the knees K, whereas a smaller diameter tree or post 10 commands a relatively shorter segment of sling material between the knees K. In addition, adjustment of the straps 34, 36 is also based on personal preference to achieve the desired solid and stable feel or support of the knees K in the knee pockets 50 and the ability to change positions if desired to relieve pressure points or adjust the support profile offered by the sling 12.

According to a preferred embodiment, the sling 12 has a length between ends 18, 20 ranging from 30 to 40 inches. The adjustable length strap assemblies 34, 36 each have an adjustable length ranging from 4 inches at their shortest length between their connection points to 12 inches at their largest length. The straps 40 may have a length ranging from 14 to 20 inches. The end loops 42, 46 are preferably large enough to allow the person to grab them with their hands. The end loops 42, 46 are formed by folding the straps ends back on themselves and then sewing or riveting the folded portion. The buckles 38, 44 are preferably installed on the straps 46 before the loops 42, 46 are formed such that the buckles 38, 44 are captured on the straps 46.

The width of the sling 12 between the top and bottom edges 22, 24 is also an important consideration to make the assembly 10 suitable as a knee sling support 10, especially in the knee pocket 50 area. The width of the sling 12 needs to cover the knees K and be comfortable and not cutting or binding. A width of 4 to 8 inches, and ideally about 5.5 inches, has shown to achieve the desired result of supporting the knees with stability and comfort. FIG. 10 illustrates the width of the sling 12 being large enough to full cover and even extend above the knees K when pocketed. The coverage offered by the wide sling 12 helps keep the person's knees K and legs from directly engaging the tree or post T for maximum comfort.

The above description is directed to a preferred embodiment of the invention and is descriptive rather than limiting. The invention is defined in the claims. Those of ordinary skill in the art will appreciate that the invention may be carried out in forms and variations that may differ from the described embodiments but which are contemplated and covered by the scope of the claims.

What is claimed is:

1. A sling assembly for supporting the knees of a person against a tree or pole while suspended in a climbing saddle or harness, the assembly comprising:
a sling of flexible material having a front side and a back side and extending longitudinally between opposite first and second ends;
a first strap assembly extending from the first end of the sling;
a second strap assembly separate from the first strap assembly and extending from the second end of the sling; the first and second strap assemblies each having connectors for releasable attachment to the saddle or harness;
at least the first strap assembly including at least one length adjuster to enable the person to selectively increase or decrease the effective length of the first strap assembly;
wherein when the connectors of the first and second strap assemblies are releasably secured to the saddle or harness, the sling forms a closed loop with the saddle or harness wherein the strap assemblies extend along the thighs of the user and the front side of the sling wraps around the user's knees, and wherein the opposite back side of the sling is engagable with the tree or pole in a space between the user's knees to shape the sling under the weight of the user to form convex and laterally spaced knee pockets on the front side of the sling and a convex tree or pole pocket on the back side of the sling to receive the tree or pole into the space between the user's knees.

2. The sling assembly of claim 1, wherein the at least one length adjuster is operative to increase or decrease the length of the closed loop to accommodate the user and different size and shapes of trees or poles.

3. The sling assembly of claim 1, wherein both straps have at least one length adjuster.

4. The sling assembly of claim 3, wherein both straps have two length adjusters.

5. The sling assembly of claim 4, wherein the at least two length adjusters comprise a slide buckles.

6. The sling assembly of claim 5, wherein a first pair of slide buckles are secured to the first and second ends of the sling.

7. The sling assembly of claim 6, wherein a second pair of slide buckles are spaced from the first pair and comprise slide buckle G-hook connectors for releasable attachment to the saddle or harness.

8. The sling assembly of claim 7 wherein the slide buckles and slide buckle G-hook connectors enable independent length adjustment of each of the strap assemblies.

9. The sling of claim 3, wherein the straps comprise webbing.

10. The sling assembly of claim 1, wherein the sling has a length of 30 to 40 inches.

11. The sling assembly of claim 10, wherein the sling has a width of 4 to 8 inches.

12. The sling assembly of claim 11, wherein the strap assemblies have an adjustable length between 4 inches and 18 inches between shortest and longest adjustment lengths.

13. The sling assembly of claim 1, wherein the sling has at least one layer made of mesh fabric.

14. The sling assembly of claim 13, wherein the sling further includes a padding layer.

15. The sling assembly of claim 14, wherein the sling further includes a second mesh layer and wherein the padding layer is disposed between the two mesh layers.

16. The sling assembly of claim 15 wherein the padding layer is perforated to permit airflow through the two mesh layers and foam layer.

17. The sling assembly of claim 15, wherein the sling includes seam binding extending about a perimeter of the sling.

18. A method of supporting a person's knees while suspended in a tree or pole while wearing a saddle or harness, the method comprising:
connecting opposite ends of a knee sling to the saddle or harness to form a knee sling loop; and
positioning the knee sling loop to extend along the person's thighs and to wrap forward around the person's knees such that when the person leans into the tree or pole, the knee sling engages the tree on a backside of the knee sling and supports the person's knees on a front side.

19. The method of claim 18, including spreading the person's knees to straddle the tree or pole and to conform the sling loop into an M shape with convex knee pockets on laterally opposite sides of the tree or pole on the front side of the knee sling to support the person's knees and a convex tree or pole pocket on the back side of the knee sling projecting into a space between the person's knees to receive the tree or pole.

20. The method of claim 16, including increasing or decreasing the size of the sling loop to adjust for larger or smaller trees or poles or personal preference.

21. The method of claim 16, including providing G-hooks on straps extending from opposite ends of the sling for releasable connection to loops provided on the saddle or harness.

22. The method of claim 16, including providing slide buckles and straps extending from opposite ends of the knee sling and adjusting the effective length of the straps by sliding the straps through the slide buckles.

23. In combination: a saddle or harness and a knee sling, wherein the saddle or harness is to be worn by a person when tethered to a tree or pole to suspend the person and wherein the knee sling is releasably attachable to the saddle or harness to extend forwardly along the person's thighs and to wrap about the person's knees such that when the person leans the wrapped knee sling into the tree or pole with knees spaced the knee sling flexes to receive the tree or pole into the space between the knees and the sling further conforms to form convex knee pockets on laterally opposite sides of the tree or pole for supporting the person's knees in straddled relation to the tree or pole.

24. The combination of claim 20, wherein the knee sling is adjustable in length to accommodate trees or poles of different diameter.

25. The combination of claim 21, wherein the knee sling includes a pair of pull straps and sliders for selectively increasing and decreasing the operative length of the knee sling.
